(19) United States
(12) Patent Application Publication
(10) Pub. No.: US 2015/0336464 A1
(43) Pub. Date: Nov. 26, 2015

(54) ULTRASONIC LOCATION FOR ELECTRIC VEHICLE CHARGING SYSTEM

(71) Applicant: FORD GLOBAL TECHNOLOGIES, LLC, Dearborn, MI (US)

(72) Inventors: Christopher W. BELL, Livonia, MI (US); John Paul GIBEAU, Canton, MI (US); William Christopher TREGO, Berkley, MI (US); James A. LATHROP, Saline, MI (US); Karin LOVETT, Novi, MI (US)

(73) Assignee: FORD GLOBAL TECHNOLOGIES, LLC, Dearborn, MI (US)

(21) Appl. No.: 14/286,189

(22) Filed: May 23, 2014

(51) Int. Cl. B60L 11/18

(52) U.S. Cl. CPC B60L 11/182

(57) ABSTRACT

A charging system for charging a vehicle includes a charging station and a vehicle. The charging station includes a wireless charging coil, at least one ultrasonic sensor oriented to detect a vehicle proximate the coil, and a first wireless communication device. The vehicle includes a charge plate, a second wireless communications device in communication with the first wireless communication device, an in-vehicle display, and at least one controller. The controller is configured to present positional information via the display. The positional information corresponds to a vehicle position detected by the at least one sensor and transmitted via the first and second wireless communications devices.

### TECHNICAL FIELD

This disclosure relates to charging stations and the recharging of batteries in electric and hybrid electric vehicles.

### BACKGROUND

Charging methods for battery electric vehicles (BEVs) and plug-in hybrid electric vehicles (PHEVs) have increased in prevalence as advancements in vehicle propulsion and battery technology have occurred. Some charging methods include wireless charging, such as inductive charging. Inductive charging systems include a primary charging coil that is energized with an electric current. The primary charging coil induces a current in a secondary charging coil, which may be used to charge a battery.

### SUMMARY

A charging system for charging a vehicle according to the present disclosure includes a charging station and a vehicle. The charging station includes a wireless charging coil, at least one ultrasonic sensor oriented to detect a vehicle proximate the coil, and a first wireless communication device. The vehicle includes a charge plate, a second wireless communications device in communication with the first wireless communication device, an in-vehicle display, and at least one controller. The controller is configured to present positional information via the display. The positional information corresponds to a vehicle position detected by the at least one sensor and transmitted via the first and second wireless communications devices.

In one embodiment, the controller is further configured to coordinate an automatic vehicle parking event in response to the positional information. In some embodiments, the charging system additionally includes a housing retaining the at least one sensor, a base supporting the coil, and a linkage coupling the base and housing. The linkage may be an adjustable-length linkage. The housing may include a first portion on a first side of the coil, a second portion on a second side of the coil, and a third portion on a third side of the coil. In such an embodiment, a first sensor is retained in the first portion, a second sensor is retained in the second portion, and a third sensor is retained in the third portion. Some embodiments additionally include a target member extending from the housing that includes a driver targeting aid. The target member is offset from a centerline of the housing to a position corresponding with a vehicle driver seat.

A wireless charging station for a vehicle according to the present disclosure includes a wireless charging coil. The station additionally includes a first housing proximate the coil and a first sensor retained within the housing and oriented to detect a vehicle proximate the coil. The charging station further includes a wireless communications device in communication with the sensor and configured to transmit positional data corresponding to a detected vehicle to an associated vehicle communications device.

In some embodiments, the sensor is an ultrasonic sensor. In one embodiment, the charging station further includes a second housing and a third housing coupled at opposing ends of the first housing to define a generally U-shaped combined housing. Such embodiments include a second sensor retained within the second housing and a third sensor retained within the third housing. Some embodiments additionally include a base supporting the coil and a linkage coupling the housing to the base station. The linkage may be an adjustable-length linkage. Some embodiments further include a target member extending from the housing and including a driver targeting aid. The target member is offset from a centerline of the housing to a position corresponding with a vehicle driver seat.

A plug-in vehicle according the present disclosure includes a wireless charging coil, a wireless communications device, an in-vehicle display, and at least one controller. The controller is configured to present positional information via the display. The positional information is received via the wireless communications device from an associated wireless charging station, where the associated charging station includes a sensor oriented to detect a vehicle proximity to the wireless charging coil. In some embodiments, the controller is further configured to coordinate an automatic vehicle parking event in response to the positional information.

Embodiments according to the present disclosure provide a number of advantages. For example, the present disclosure provides a charging station that provides positional information to the vehicle. This information may enable a driver to more accurately position the vehicle relative to a wireless charging coil for battery charging. In addition, this positional information may be used in conjunction with an automatic park system to accurately auto-park the vehicle proximate a wireless charging coil. Systems according the present disclosure include sensors located on a charging station rather than on the vehicle. The sensors thus do not need to be designed to withstand road hazards and may be made with reduced costs.

The above and other advantages and features of the present disclosure will be apparent from the following detailed description of the preferred embodiments when taken in connection with the accompanying drawings.

### BRIEF DESCRIPTION OF THE DRAWINGS

FIG. 1 is a schematic representation of a wireless charging station for an electric vehicle according to the present disclosure;

FIG. 2 is a schematic representation of a wireless charging system according to the present disclosure including a charging station and a plug-in vehicle; and

FIG. 3 illustrates a method for controlling a vehicle charging system according to the present disclosure in flowchart form.

### DETAILED DESCRIPTION

As those of ordinary skill in the art will understand, various features of the present invention as illustrated and described with reference to any one of the Figures may be combined with features illustrated in one or more other Figures to produce embodiments of the present disclosure that are not explicitly illustrated or described. The combinations of features illustrated provide representative embodiments for typical applications. However, various combinations and modifications of the features consistent with the teachings of the present disclosure may be desired for particular applications or implementations.

Vehicles may be powered by battery electricity (BEVs) as well as by a combination of power sources including battery electricity. For example, hybrid electric vehicles (HEVs) are contemplated in which the powertrain is powered by both a battery and an internal combustion engine. In these configurations, the battery is rechargeable and a vehicle charger provides power to restore the battery after discharge.

Some vehicles and associated charging stations are equipped for hands-free wireless charging. To charge vehicles using such a system, the vehicle must be precisely located relative to the charger. A secondary charging coil in the vehicle must be positioned within a certain distance and orientation of a primary charging coil in order to effectively charge a vehicle battery.

One possible solution includes providing sensors on the vehicle that are equipped to detect a charging station location. However, such implementations must be sufficiently robust to function in the presence of displaced road debris including tire-propelled mud, ice, or dirt. Robust sensors capable of withstanding such road hazards may be expensive.

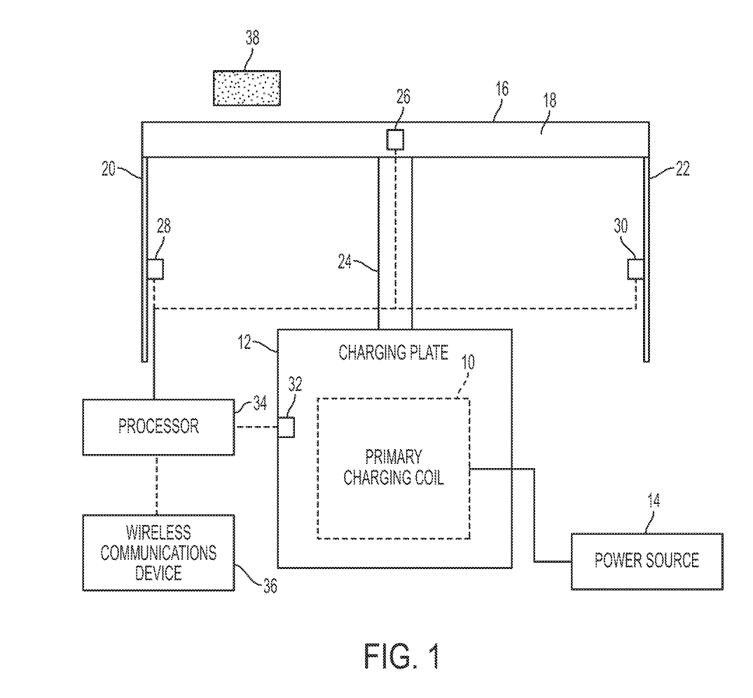

Referring now to FIG. 1, a top view of a wireless charging station according to the present disclosure is illustrated in schematic form. The charging station is configured for inductive charging and includes a primary charging coil 10 housed within a primary induction charging plate 12. The primary charging coil 10 is electrically connected to an electric power source 14. The power source 14 provides current to the primary charging coil 10, which generates an electromagnetic field about the primary induction charging plate 12. When a corresponding secondary coil is placed in proximity to the powered primary induction charging plate 12, it receives power by being within the generated electromagnetic field. The primary induction charging plate 12 may, in some embodiments, be provided with an articulated arrangement to raise and lower the primary charging coil relative to a vehicle for charging.

The wireless charging station additionally includes a housing 16. The housing is positioned proximate the primary induction charging plate 12. The housing 16 includes a central portion 18 with a long side facing the primary induction charging plate 12. The housing 16 additionally includes a first arm 20 and a second arm 22 extending from opposing ends of the central portion 18. The housing 16 is thus generally U-shaped. The width of the central portion 18 preferably exceeds the width of the primary induction charging plate 12, such that the first arm 20 and second arm 22 extend on opposing sides of the primary induction charging plate 12. In addition, the width of the central portion 18 should preferably exceed the width of any automobiles intended for use with the charging station. Thus when a vehicle is properly located relative to the primary induction charging plate 12 for charging, the first arm 20 and second arm 22 extend on opposing sides of the vehicle.

The housing 16 is connected to the primary induction charging plate 12 via a linkage 24. In a preferred embodiment, the linkage 24 is an adjustable-length linkage. The linkage 24 may be adjusted based on dimensions of a vehicle intended for use with the charging station and the location of a secondary charging coil in the vehicle. The linkage is thus used to provide a proper distance between the housing 16 and primary induction charging plate 12.

The wireless charging station additionally includes sensors 26, 28, and 30 associated with the housing and generally oriented toward the primary induction charging plate 12. In a preferred embodiment, sensor 26 is associated with the central portion 18, sensor 28 is associated with the first arm 20, and sensor 30 is associated with the second arm 22. The wireless charging station further includes a sensor 32 operatively coupled with the primary induction charging plate 12. Thus, as a vehicle approaches the primary induction charging plate 12 for charging, the sensor 32 provides a first sensor reading indicative of the approaching vehicle. As the vehicle continues to pull forward toward a proper location for charging, sensor 26 is oriented toward a first side of the vehicle, sensor 28 toward a second side of the vehicle, and sensor 30 toward a third side of the vehicle. Sensor 26 provides a measurement of the vehicle location in a longitudinal, i.e. front-to-back, direction, and sensors 28 and 30 provide a measurement of the vehicle location in a lateral, i.e. side-to-side, direction. Thus the combination of sensors provides accurate positional information for the vehicle.

In a preferred embodiment, the sensors 26, 28, 30, and 32 are ultrasonic sensors. Such sensors emit ultrasonic waves that may be reflected by objects in their path. By measuring time between the transmission of the ultrasonic wave and receipt of the reflected signal, the distance of the object can be calculated. In some embodiments other types of sensors may be used, or a combination of ultrasonic and other sensors may be used. Additional sensors beyond the three illustrated may, of course, also be used.

The sensors 26, 28, 30, and 32 are in communication with a processor 34. The processor 34 is configured to calculate a position of a vehicle, including longitudinal and lateral displacement relative to the primary induction charging plate 12, in response to signals from the sensors 26, 28, 30, and 32. The processor 34 is additionally in communication with a wireless communications device 36. The processor 34 is configured to transmit positional information of a vehicle to the vehicle via the wireless communications device 36. The processor 34 and wireless communications device 36 may be retained within the housing 16, primary induction charging plate 12, or other appropriate location. Communications cables may be run through the linkage 24 between components retained within the housing 16 and components retained within the primary induction charging plate 12.

The charging station may additionally include a target member 38. The target member 38 provides a visual reference point by which a driver may orient the position of a vehicle relative to the charging station and thus serves in conjunction with positional information from the sensors 26, 28, 30, and 32. The target member 38 may be a separate device from the housing 16, as illustrated, or may couple with and extend from the housing 16. In a preferred embodiment, the target member 38 is offset toward the driver's side and not centered relative to the charging station. This reduces the risk of driver position miscalculation due to parallax error, which may arise when a driver attempts to determine the distance or direction to a point that is offset from the driver's direct line of sight.

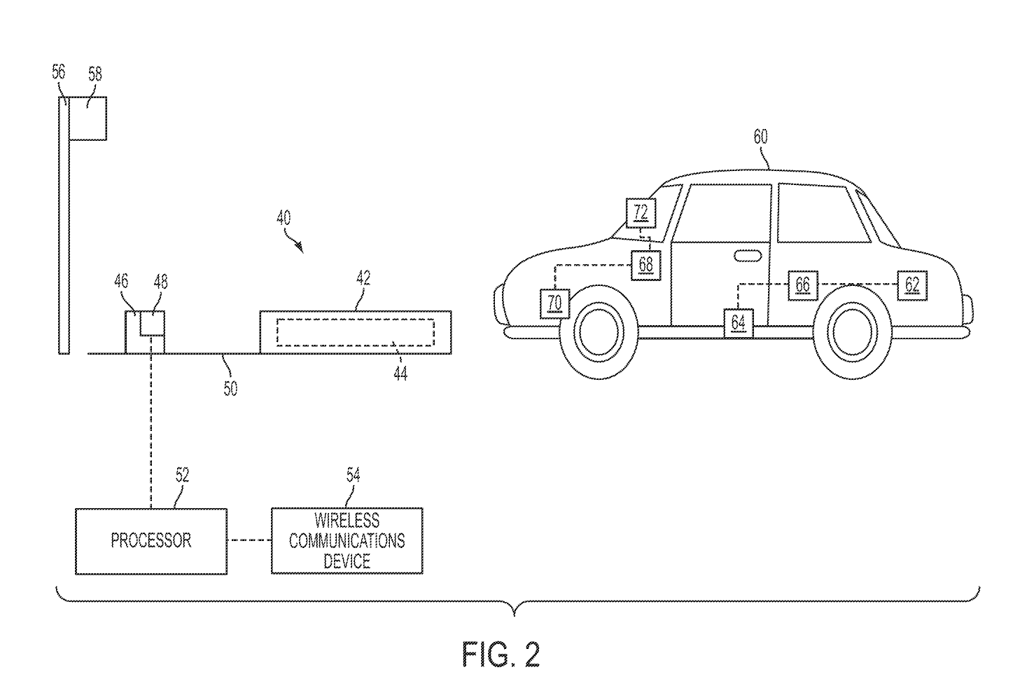

Referring now to FIG. 2, a charging system is illustrated including a charging station 40. The charging station 40 may be substantially as described above with respect to FIG. 1. The charging station 40 includes a primary induction charging plate 42 retaining a primary induction coil 44, a housing 46 and an associated sensor 48 which may be an ultrasonic sensor, and a linkage 50 coupling the housing 46 with the primary induction charging plate 42. The charging station includes a processor 52 in communication with the sensor 48. The processor 52 is also in communication with a wireless communications device 54. The processor 52 and wireless communications device 54 may be retained within the housing 46, primary induction charging plate 42, or other appropriate location. Communications cables may be run through the linkage 50.

The charging system additionally includes a target member 56 including a driver targeting aid 58. The driver targeting aid 58 is a visual reference for the driver that may include a bull's-eye, crosshair, or other appropriate target identification device.

The charging system additionally includes a vehicle 60. The vehicle 60 is a battery electric vehicle (BEV) or plug-in hybrid electric vehicle (PHEV). The vehicle 60 includes a battery 62 and a secondary induction coil 64. The secondary induction coil 64 generates current in response to an electromagnetic field generated by the primary induction coil 44. The vehicle 60 additionally includes an AC-to-DC converter 66. The converter 66 rectifies and filters AC power generated by the secondary induction coil 64 to DC power to recharge the battery 62.

The vehicle 60 additionally includes at least one controller 68. Although it is shown as a single controller, the vehicle controller 68 can include multiple controllers that are used to control multiple vehicle systems. For example, the vehicle controller 68 can be a vehicle system controller/powertrain control module (VSC/PCM). In this regard, the vehicle charging control portion of the VSC/PCM can be software embedded within the VSC/PCM, or it can be implemented in a separate hardware device. The vehicle controller 68 generally includes any number of microprocessors, ASICs, ICs, memory (e.g., FLASH, ROM, RAM, EPROM and/or EEPROM) and software code to co-act with one another to perform a series of operations. The vehicle controller 68 additionally communicates with other controllers and components over a hardline vehicle connection using a common bus protocol (e.g. CAN).

The controller 68 is in electric communication with a vehicle wireless communications device 70. The vehicle wireless communications device 70 is in wireless communication with the charging station wireless communications device 54. In a preferred embodiment, the charging station wireless communications device 54 and vehicle wireless communications device 70 are both WiFi devices. Other wireless communications methods may of course be used, such as Bluetooth. The controller 68 is configured to receive positional information from the charging station 40 via the vehicle wireless communications device 70. The wireless communication between the vehicle wireless device 70 and charging station 40 may be used to transmit other information, as well. For example, the wireless communication may be used to complete an association procedure between the vehicle 60 and the charging station 40, in response to which vehicle charging may be initiated.

The controller 68 is additionally in communication with a driver display 72. The driver display may be a dashboard multifunction display or other displays as appropriate. The controller is configured to provide the positional information to a driver via the driver display 72. The driver display may include any appropriate representation of the vehicle positional information to illustrate the vehicle position and orientation relative to the primary induction charging plate 42. In response to this information, the driver may more accurately park the vehicle with the secondary induction coil 64 proximate the primary induction charging plate 42.

In some embodiments, the vehicle 60 is equipped with an auto park system. In such embodiments, a controller, which may be controller 68 or other appropriate controllers, issues commands to various vehicle systems to coordinate an automatic parking event. During an automatic parking event, vehicle steering, acceleration, and braking systems (not illustrated) are automatically controlled to park the car in an appropriate parking location and orientation. The controller will use the positional information from the charging station 40 to coordinate the various systems and park the vehicle with the secondary induction coil 64 proximate the primary induction charging plate 42 for charging.

Variations on the above system are, of course, possible. For example, the charging station may include only a single ultrasonic sensor, rather than the three sensor configuration illustrated in FIG. 1. As another example, a plurality of sensors may be retained within a single elongated housing, rather than the U-shaped configuration illustrated in FIG. 1. As yet another example, the charging station may be electrically coupled with a visual display, such as an LCD screen, and configured to display the vehicle positional information on the visual display. Such a variant has the benefit of operating regardless of the existence of wireless communication between the charging station and a vehicle.

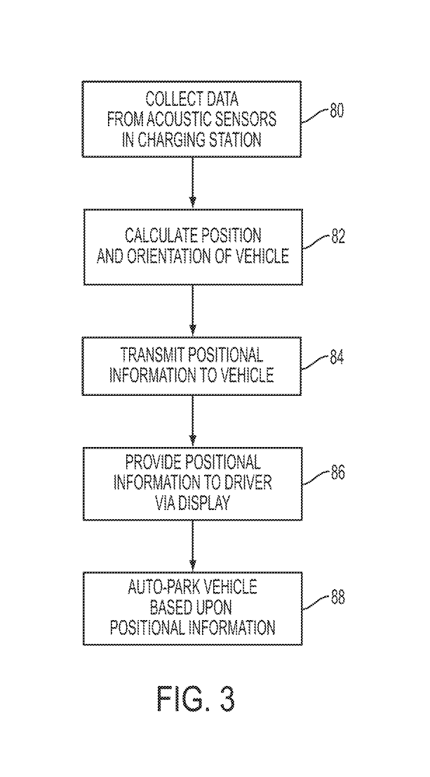

Referring now to FIG. 3, a method for controlling a vehicle charging system according to the present disclosure is illustrated in flowchart form. Data is collected from acoustic sensors disposed in a charging station, as illustrated at block 80. The position and orientation of a detected vehicle is calculated, as illustrated at block 82. Positional information is transmitted to the vehicle, as illustrated at block 84. Positional information is provided to the driver via an in-vehicle display, as illustrated at block 86. In vehicles equipped with an auto-park system, the vehicle is automatically parked based upon the positional information received from the charging station, as illustrated at block 88.

In a variation of the above method, a vehicle with an auto-park system may be configured not to display positional information to the driver, as the driver does not need to interact with the vehicle during the parking process.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

As can be seen from the various embodiments, the present invention provides a system for wirelessly charging a vehicle that enables precise vehicle parking relative to a charging station. Furthermore, systems according to the present disclosure include sensors on the charging station rather than the vehicle, and thus the sensors do not have to withstand road hazards. Costs are thus reduced.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A charging system for charging a vehicle comprising:
a charging station including a wireless charging coil, at least one ultrasonic sensor oriented to detect a vehicle proximate the coil, and a first wireless communications device; and
a vehicle including a charge plate, a second wireless communications device in communication with the first wireless communications device, an in-vehicle display, and at least one controller configured to present positional information via the display, the positional information corresponding to a vehicle position detected by the at least one sensor and transmitted between the first and second wireless communications devices.

2. The charging system of claim 1, further comprising a housing retaining the at least one sensor, a base supporting the coil, and a linkage coupling the base and housing.

3. The charging system of claim 2, wherein the linkage is an adjustable-length linkage.

4. The charging system of claim 2, wherein the housing includes a first portion on a first side of the coil, a second portion on a second side of the coil, and a third portion on a third side of the coil, and wherein the at least one sensor comprises a first sensor retained in the first portion, a second sensor retained in the second portion, and a third sensor retained in the third portion.

5. The charging system of claim 2, further comprising a target member proximate the housing and including a driver targeting aid, the housing having a centerline and the target member being offset from the centerline to a position corresponding with a vehicle driver seat.

6. The charging system of claim 1, wherein the at least one controller is further configured to coordinate an automatic vehicle parking event in response to the positional information.

7. A wireless charging station for a vehicle comprising:
a wireless charging coil;
a first housing proximate the coil;
a first sensor retained within the housing and oriented to detect a vehicle proximate the coil; and
a wireless communications device in communication with the sensor and configured to transmit positional data corresponding to a detected vehicle to an associated vehicle wireless communications device.

8. The wireless charging station of claim 7, wherein the first sensor is an ultrasonic sensor.

9. The wireless charging station of claim 1, further comprising a second housing and a third housing coupled at opposing ends of the first housing to define a generally U-shaped combined housing, a second sensor retained within the second housing, and a third sensor retained within the third housing.

10. The wireless charging station of claim 7, further comprising a base supporting the coil and a linkage coupling the housing to the base.

11. The wireless charging station of claim 10, wherein the linkage is an adjustable-length linkage.

12. The wireless charging station of claim 7, further comprising a target member proximate the housing and including a driver targeting aid, the housing having a centerline and the target member being offset from the centerline to a position corresponding with a vehicle driver seat.

13. The wireless charging station of claim 7, further comprising a second sensor operatively coupled with the coil and oriented to detect a vehicle proximate the coil, wherein the positional data corresponding to a detected vehicle is based on signals from the first and second sensors.

14. A plug-in vehicle comprising:
a wireless charging coil;
a wireless communications device;
an in-vehicle display; and
at least one controller configured to present positional information via the display, the positional information being received via the wireless communications device from an associated wireless charging station including a sensor oriented to detect a vehicle proximity to the wireless charging coil.

15. The plug-in vehicle of claim 14, wherein the at least one controller is further configured to coordinate an automatic vehicle parking event in response to the positional information.
